(19) United States
(12) Patent Application Publication
(10) Pub. No.: US 2026/0120657 A1
(43) Pub. Date: Apr. 30, 2026

(54) LIQUID CRYSTAL DISPLAY DEVICE, AND CONTROL APPARATUS FOR LIQUID CRYSTAL PANEL

(71) Applicant: Sharp Display Technology Corporation, Kameyama City (JP)

(72) Inventors: Kohji SAITOH, Kameyama City (JP); Jin MIYAZAWA, Kameyama City (JP); Yousuke NAKAMURA, Kameyama City (JP); Tatsuya HAYASHI, Kameyama City (JP); Kohji YABUTA, Kameyama City (JP)

(21) Appl. No.: 19/181,602

(22) Filed: Apr. 17, 2025

(30) Foreign Application Priority Data
Apr. 24, 2024 (JP) 2024-070818

(51) Int. Cl. G09G 3/36

(52) U.S. Cl. CPC G09G 3/3614; G09G 2310/08; G09G 2340/16

(57) ABSTRACT

A liquid crystal display device, includes a display unit including a first region and a second region, the first region and the second region being supplied with a data signal a polarity of which is cyclically reversed, so that display data of the first region and the second region is cyclically updated, wherein, in a first period, a refresh rate for the first region is set to a first frequency and a refresh rate for the second region is set to a second frequency lower than the first frequency, and in the first period, a polarity reversal rate of the data signal is set to a common frequency in common to the first region and the second region, and the common frequency is lower than, or equal to the second frequency.

### CROSS-REFERENCE TO RELATED APPLICATIONS

The present application claims priority from Japanese Application JP2024-070818, the content of which is hereby incorporated by reference into this application.

### BACKGROUND

### Technical Field

The present disclosure relates to a liquid crystal display device.

Japanese Unexamined Patent Application Publication No. 2016-133630 discloses a technique to improve display quality when a liquid crystal display device selectively displays images having different refresh rates.

### SUMMARY

When a liquid crystal display device displays a plurality of images having different refresh rates, the display quality might deteriorate.

A liquid crystal display device according to an aspect of the present disclosure includes a display unit including a first region and a second region, the first region and the second region being supplied with a data signal a polarity of which is cyclically reversed, so that display data of the first region and the second region is cyclically updated. In a first period, a refresh rate for the first region is set to a first frequency and a refresh rate for the second region is set to a second frequency lower than the first frequency. In the first period, a polarity reversal rate of the data signal is set to a common frequency in common to the first region and the second region, and the common frequency is lower than, or equal to the second frequency.

A liquid crystal display device according to an aspect of the present disclosure can display a plurality of images having different refresh rates in high quality.

### BRIEF DESCRIPTION OF THE DRAWINGS

FIG. 1 is a block diagram illustrating a configuration of a liquid crystal display device according to this embodiment;

FIG. 2 illustrates an example of how the liquid crystal display device operates;

FIG. 3 illustrates an example of how the liquid crystal display device operates;

FIG. 4 illustrates a comparative example;

FIG. 5 illustrates an example of how the liquid crystal display device operates;

FIG. 6 illustrates an example of how the liquid crystal display device operates;

FIG. 7 illustrates an example of how the liquid crystal display device operates;

FIG. 8 illustrates an example of how the liquid crystal display device operates;

FIG. 9 illustrates an example of how the liquid crystal display device operates;

FIG. 10 illustrates an example of how the liquid crystal display device operates; and

FIG. 11 illustrates an example of how the liquid crystal display device operates.

### DESCRIPTION OF EMBODIMENTS

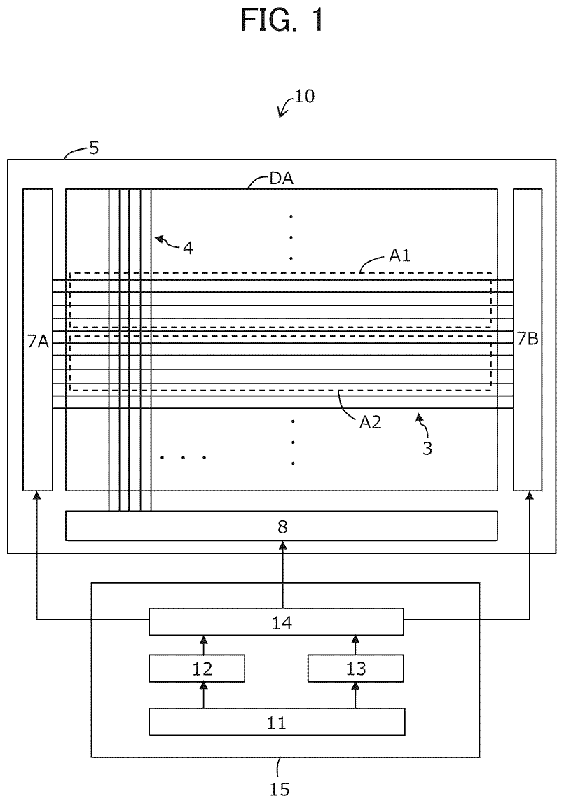

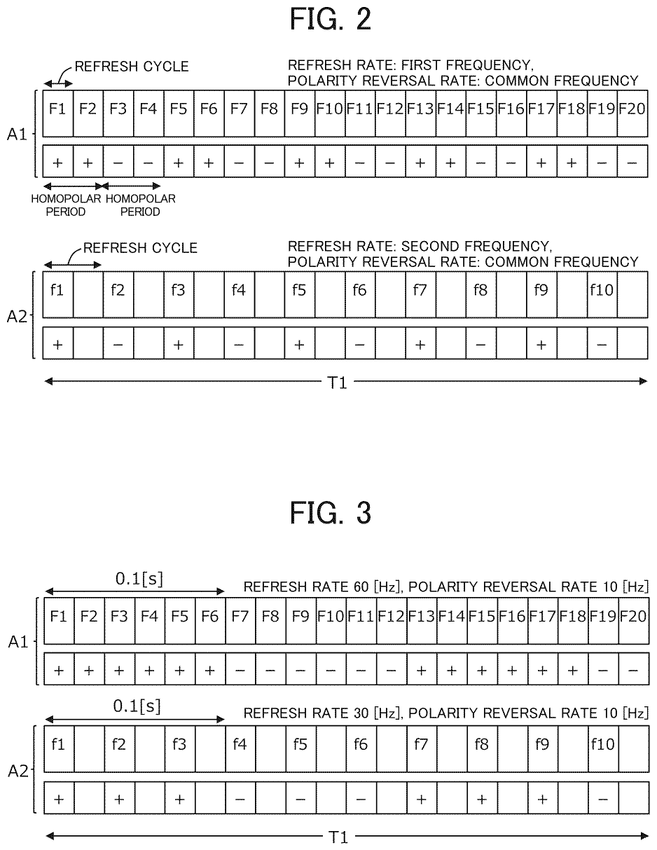

FIG. 1 is a block diagram illustrating a configuration of a liquid crystal display device according to this embodiment. FIG. 2 illustrates an example of how the liquid crystal display device operates. As illustrated in FIG. 1, a liquid crystal display device 10 includes a display unit DA including a first region A1 and a second region A2. The first region A1 and the second region A2 are supplied with a data signal a polarity of which is cyclically reversed, so that display data of the first region A1 and the second region A2 is cyclically updated.

FIG. 2 shows that, as to the liquid crystal display device 10, in a first period T1, a refresh rate for the first region A1 is set to a first frequency, and a refresh rate for the second region A2 is set to a second frequency lower than the first frequency (e.g., a half of the first frequency in FIG. 2). In the first period T1, a polarity reversal rate of the data signal is set to a common frequency in common to the first region A1 and the second region A2. The common frequency is lower than, or equal to, the second frequency (e.g., the second frequency in FIG. 2). Refreshing involves updating (writing) display data. In refreshing, the display data per se may or may not be changed.

Thanks to such features, in the first region A1 and the second region A2, a homopolar period (a half of a polar cycle) in which homopolarity is maintained is the same as, or longer than, a refresh cycle (a refresh interval) for the second region A2. Hence, the features can reduce polarity imbalance of a voltage to be applied to the second region A2 (i.e., a DC component to the second region A2). Thanks to the reduction in polarity imbalance, a plurality of images (i.e., images in the first region A1 and the second region A2) having different refresh rates can be displayed in high quality. Furthermore, compared with a case where the refresh rate for the second region A2 is set to the first frequency (to match the first region A1), power consumption is reduced, and up-conversion of a frame rate is not required. In FIG. 1 and FIG. 2, the first region A1 may display a moving image and the second region A2 may display a still image.

The common frequency may be a common divisor of the first frequency and the second frequency, a greatest common divisor of the first frequency and the second frequency, or an integer smaller than, or equal to, the greatest common divisor.

As to the liquid crystal display device 10, the polarity reversal rate for the display unit DA as a whole including the first region A1 and the second region A2 may be set to the common frequency. The liquid crystal display device 10 may include: a scan signal line group 3 laid in a first direction D1; and a data signal line group 4 laid in a second direction D2 perpendicular to the first direction D1. The first region A1 and the second region A2 do not have to overlap with each other and may be different in position of the first direction D1.

As illustrated in FIG. 1, the liquid crystal display device 10 may include: a liquid crystal panel 5 including the first region A1, the second region A2, the scan signal line group 3 scanned sequentially, the data signal line group 4 supplied with a data signal, and a scan driver 7A and a scan driver 7B to drive the scan signal line group 3; a data driver 8 to drive the data signal line group 4; and a control apparatus 15 to control the scan driver 7A, the scan driver 7B, and the data driver 8. The liquid crystal panel 5 may include: a TFT substrate; a counter substrate; and a liquid crystal layer positioned between the TFT substrate and the counter substrate.

Each of the first region A1 and the second region A2 includes a plurality of subpixels. Each of the subpixels has a liquid crystal capacitance including a pixel electrode and a counter electrode. A voltage held in the liquid crystal capacitance corresponds to display data of the subpixel. If each subpixel includes a color filter in a predetermined color, the subpixel displays a predetermined color at a grayscale level corresponding to the display data. The color filter may be provided to the counter substrate. The pixel electrode and the counter electrode (a common electrode) may be provided to the TFT substrate (i.e., an in-plane mode). The pixel electrode may be provided to the TFT substrate, and the counter electrode (the common electrode) may be provided to the counter substrate (i.e., a vertical alignment mode).

The control apparatus 15 includes: a video input unit 11; a video processing unit 12; a timing signal generating unit 13; and an output signal generating unit 14. The video input unit 11 receives video data from outside. The video processing unit 12 processes the video data received from the video input unit 11. The timing signal generating unit 13 generates a timing signal in accordance with a common frequency stored in an internal memory and the video data received from the video input unit 11. The output signal generating unit 14 generates an output signal using the timing signal received from the timing signal generating unit 13 and the video data processed by the video processing unit 12, and supplies the output signal to the scan driver 7A, the scan driver 7B, and the data driver 8. The control apparatus 15 may be a timing controller. The control apparatus 15 and the data driver (a source driver) 8 may be formed as separate LSIs or integrated into a single LSI. The common frequency may be either stored in a memory of the control apparatus 15 or read from outside by the control apparatus 15. The common frequency may be either a fixed value or a parameter corresponding to the video data.

In FIG. 2, Fn represents a period (i.e., a refresh period) in which an n-th frame (n is an integer) is refreshed for the first region A1, and fn represents a period (i.e., a refresh period) in which an n-th frame is refreshed for the second region A2. The first period T1 in FIG. 2 includes: a scan period (such as F2, F4, and F6) in which a plurality of scan signal lines corresponding to the first region A1 is scanned so that the first region A1 is refreshed, while a plurality of scan signal lines corresponding to the second region A2 is not scanned so that the second region A2 is not refreshed; and a scan period (such as F1 (f1), F3 (f2), and F5 (f3)) in which the plurality of scan signal lines corresponding to the first region A1 and the plurality of scan signal lines corresponding to the second region A2 are scanned. That is, the first period T1 may have: a scan period (i.e., a vertical scan period) including Fn and fm (m is a natural number); and a scan period (i.e., a vertical scan period) including Fn and omitting fm. In the scan period (i.e., the vertical scan period) including Fn and fm, Fn may be a period either preceding or succeeding fm. In the scan period (i.e., the vertical scan period), the data signal may be maintained to be homopolar (i.e., either positive or negative). Then, in scan periods (F1 (f1), F7 (f4), and F13 (f7)) with polarity reversal timings of the data signal, the plurality of scan signal lines corresponding to the first region A1 and the plurality of scan signal lines corresponding to the second region A2 are scanned.

FIG. 3 illustrates an example of how the liquid crystal display device operates. FIG. 3 shows that, in the first period T1, the refresh rate (i.e., the first frequency) for the first region A1 is set to 60 [Hz] and the refresh rate (i.e., the second frequency) for the second region A2 is set to 30 [Hz]. In the first period T1, the polarity reversal rate (i.e., the common frequency) of the data signal is set to 10 [Hz] that is lower than, or equal to, the second frequency. Specifically, a period between F1 and F6 (f1 and f3) is 0.1 [sec], and the common frequency is a common divisor of the first frequency and the second frequency.

FIG. 3 shows that the homopolar period (0.1 sec.) in which the homopolarity is maintained is longer than the refresh cycle (0.033 sec.) for the second region A2. In addition, the scan periods (corresponding to F1, F7, and F13) with polarity reversal timings of the data signal match the refresh periods f1, f4, and f7 of the second region A2 (i.e., in the scan periods when the polarity of the data signal is reversed, the second region A2 is refreshed). Such features can reduce polarity imbalance of a voltage to be applied to the second region A2 (i.e., a DC component to the second region A2).

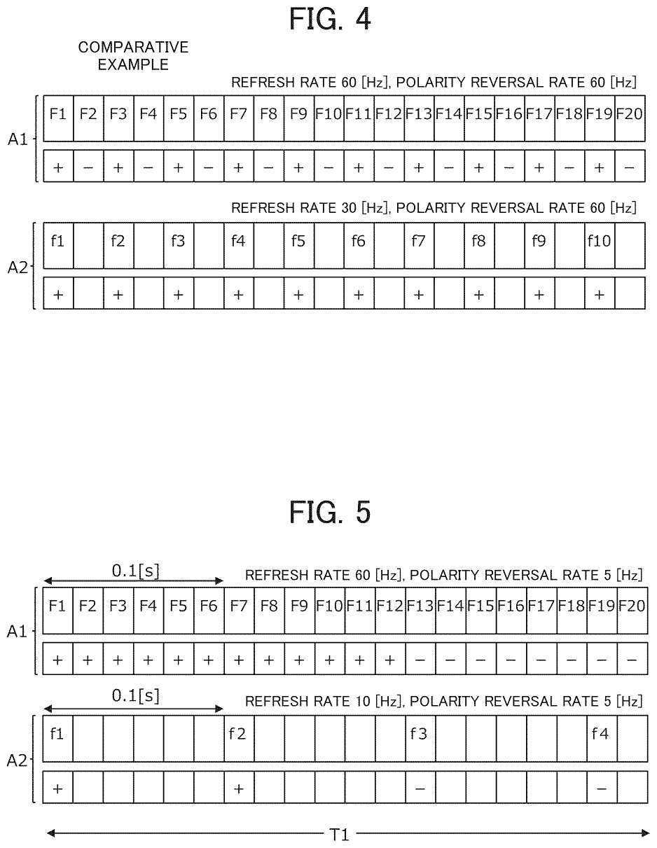

FIG. 4 illustrates a comparative example. FIG. 4 shows that the refresh rate for the first region A1 is set to 60 [Hz] and the refresh rate for the second region A2 is set to 30 [Hz]. The polarity reversal rate in common to the first region A1 and the second region A2 is set to 60 [Hz]. In the case of FIG. 4, a homopolar period in which homopolarity is maintained is shorter than a refresh cycle for the second region A2. Hence, homopolarity is written to each of the refresh periods f1 to f10 for the second region A2. This increases polarity imbalance of a voltage to be applied to the second region A2 (i.e., a DC component to the second region A2). As a result, the display quality deteriorates.

FIG. 5 illustrates an example of how the liquid crystal display device operates. FIG. 5 shows that, in the first period T1, the refresh rate (i.e., the first frequency) for the first region A1 is set to 60 [Hz] and the refresh rate (i.e., the second frequency) for the second region A2 is set to 10 [Hz]. In the first period T1, the polarity reversal rate (i.e., the common frequency) of the data signal is set to 5 [Hz] that is lower than, or equal to, the second frequency. Specifically, a period between F1 and F6 (f1 and f3) is 0.1 [sec], and the common frequency is a common divisor of the first frequency and the second frequency.

FIG. 5 shows that the homopolar period (0.2 sec.) in which the homopolarity is maintained is longer than the refresh cycle (0.1 sec.) for the second region A2. In addition, the scan periods (corresponding to F1 and F13) with polarity reversal timings of the data signal match the refresh periods f1 and f3 for the second region A2 (i.e., in the scan periods when the polarity of the data signal is reversed, the second region A2 is refreshed). Such features can reduce polarity imbalance of a voltage to be applied to the second region A2 (i.e., a DC component to the second region A2).

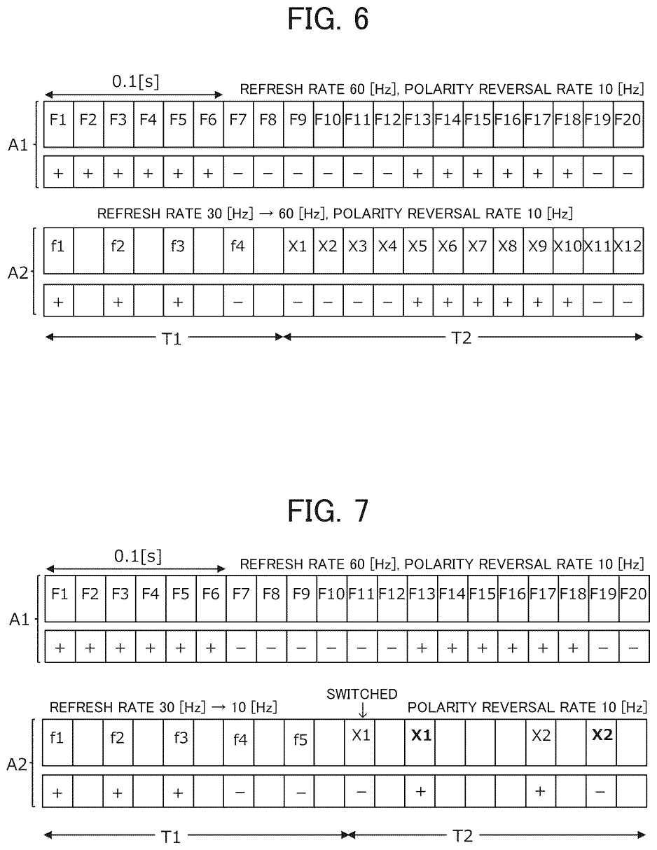

FIG. 6 illustrates an example of how the liquid crystal display device operates. FIG. 6 shows that, in the first period T1, the refresh rate (i.e., the first frequency) for the first region A1 is set to 60 [Hz] and the refresh rate (i.e., the second frequency) for the second region A2 is set to 30 [Hz]. In the first period T1, the polarity reversal rate (i.e., the common frequency) of the data signal is set to 10 [Hz] that is lower than, or equal to, the second frequency. Furthermore, in the second period T2 succeeding the first period T1, the refresh rate (i.e., the first frequency) for the first region A1 is set to 60 [Hz] and the refresh rate for the second region A2 is changed to 60 [Hz]; that is, a third frequency. In the second period T2, the polarity reversal rate (i.e., the common frequency) of the data signal is maintained at 10 [Hz]. That is, even if the refresh rate for the second region A2 is changed to a third frequency (e.g., a multiple of the second frequency) higher than the second frequency, the common frequency is left unchanged. In the second period T2, Xn represents a period (i.e., a refresh period) in which an n-th frame (n is a natural number) is refreshed for the second region A2.

In FIG. 6, in scan periods (corresponding to F13 and F19) of the second period T2 with polarity reversal timings of the data signal, the plurality of scan signal lines corresponding to the first region A1 and the plurality of scan signal lines corresponding to the second region A2 are scanned. In the second period T2, the homopolar period (0.1 sec.) in which the homopolarity is maintained is longer than the refresh cycle (0.1 sec./6) for the second region A2. In addition, the scan periods (corresponding to F13 and F19) with polarity reversal timings of the data signal match the refresh periods X5 and X11 for the second region A2. Such features can reduce polarity imbalance of a voltage to be applied to the second region A2 (i.e., a DC component to the second region A2).

FIG. 7 illustrates an example of how the liquid crystal display device operates. FIG. 7 shows that, in the first period T1, the refresh rate (i.e., the first frequency) for the first region A1 is set to 60 [Hz] and the refresh rate (i.e., the second frequency) for the second region A2 is set to 30 [Hz]. In the first period T1, the polarity reversal rate (i.e., the common frequency) of the data signal is set to 10 [Hz] that is lower than, or equal to, the second frequency. Furthermore, in the second period T2 succeeding the first period T1, the refresh rate (i.e., the first frequency) for the first region A1 is set to 60 [Hz] and the refresh rate for the second region A2 is changed (switched) to 10 [Hz]; that is, the third frequency. In the second period T2, the polarity reversal rate (i.e., the common frequency) of the data signal is maintained at 10 [Hz]. That is, even if the refresh rate for the second region A2 is changed to the third frequency (e.g., a submultiple of the second frequency) lower than the second frequency and higher than, or equal to, the common frequency, the common frequency is left unchanged. In the second period T2, Xn represents a period (i.e., a refresh period) in which an n-th frame (n is a natural number) is refreshed for the second region A2.

The second period T2 in FIG. 7 includes: a scan period (such as F12 and F14) in which a plurality of scan signal lines corresponding to the first region A1 is scanned so that the first region A1 is refreshed, while a plurality of scan signal lines corresponding to the second region A2 is not scanned so that the second region A2 is not refreshed; and a scan period (such as F11 (X1) and F17 (X2)) in which the plurality of scan signal lines corresponding to the first region A1 and the plurality of scan signal lines corresponding to the second region A2 are scanned. In scan periods (corresponding to F13 and F19) of the second period T2 with polarity reversal timings of the data signal, the plurality of scan signal lines corresponding to the first region A1 and the plurality of scan signal lines corresponding to the second region A2 are scanned.

Furthermore, in the second period T2, even if the polarity reversal timing of the data signal does not match a timing when the second region A2 is refreshed (i.e., a refresh period), the plurality of scan signal lines corresponding to the second region A2 is scanned in a scan period with the polarity reversal timing. That is, as shown in FIG. 7, the plurality of scan signal lines corresponding to the second region A2 is scanned in the scan period (including F13) with the polarity reversal timing so that a first frame that has been switched to is forced to be rewritten, and the plurality of scan signal lines corresponding to the second region A2 is scanned in the scan period (including F19) with the polarity reversal timing so that a second frame that has been switched to is forced to be rewritten.

FIG. 7 shows that, in the second period T2, the homopolar period (0.1 sec.) in which the homopolarity is maintained is the same as the refresh cycle for the second region A2. In addition, the scan periods (corresponding to F13 and F19) with polarity reversal timings of the data signal match the refresh periods X1 and X2 (rewrite periods) for the second region A2 (i.e., in the scan periods when the polarity of the data signal is reversed, the second region A2 is refreshed). Such features can reduce polarity imbalance of a voltage to be applied to the second region A2 (i.e., a DC component to the second region A2).

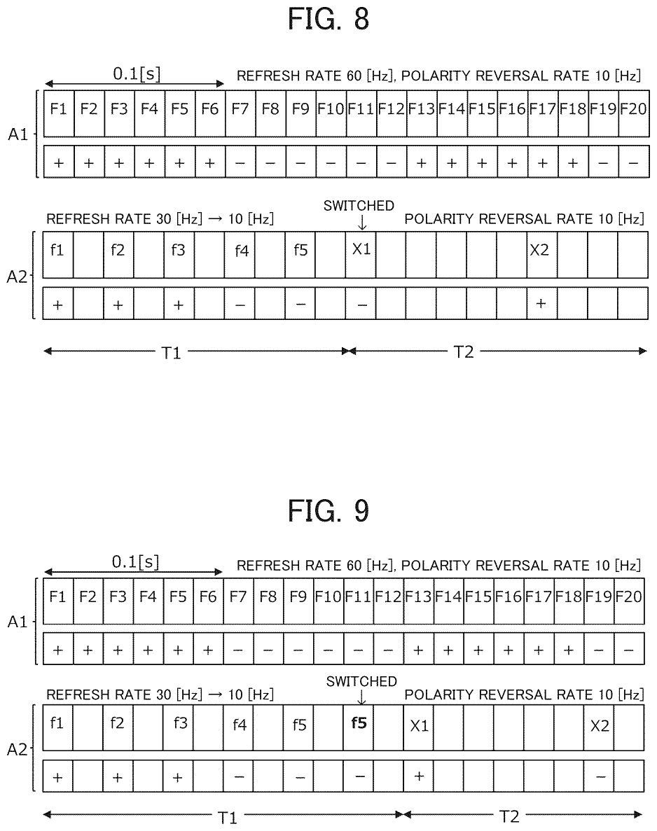

FIG. 8 illustrates an example of how the liquid crystal display device operates. In FIG. 7, rewrite (forced write) is performed in X1 and X2 of the second period T2. If the rewrite is not performed, the polarities of the first region A1 and the second region A2 are different between F13 to F16 and F19 to F20 of the second period T2. If the difference does not affect the display quality, the difference may be left as it is. However, if the difference affects the display quality, the operation of the liquid crystal display may be controlled as shown in FIG. 7.

FIG. 9 illustrates an example of how the liquid crystal display device operates. FIG. 9 shows that, in the first period T1, the refresh rate (i.e., the first frequency) for the first region A1 is set to 60 [Hz] and the refresh rate (i.e., the second frequency) for the second region A2 is set to 30 [Hz]. In the first period T1, the polarity reversal rate (i.e., the common frequency) of the data signal is set to 10 [Hz] that is lower than, or equal to, the second frequency. Furthermore, in the second period T2 succeeding the first period T1, the refresh rate (i.e., the first frequency) for the first region A1 is set to 60 [Hz] and the refresh rate for the second region A2 is changed (switched) to 10 [Hz]; that is, the third frequency. In the second period T2, the polarity reversal rate (i.e., the common frequency) of the data signal is maintained at 10 [Hz]. That is, even if the refresh rate for the second region A2 is changed to the third frequency (e.g., a submultiple of the second frequency) lower than the second frequency and higher than, or equal to, the common frequency, the common frequency is left changed. In the second period T2, Xn represents a period (i.e., a refresh period) in which an n-th frame (n is a natural number) is refreshed for the second region A2.

As shown in FIG. 9, the second region A2 may be updated once or more with identical display data (a fifth frame) at an end of the first period T1 so that a start of the second period T2 may match the polarity reversal timing (corresponding to F13) of the data signal.

FIG. 9 shows that, in the second period T2, the homopolar period (0.1 sec.) in which the homopolarity is maintained is the same as the refresh cycle for the second region A2. In addition, the scan periods (corresponding to F13 and F19) with polarity reversal timings of the data signal match the refresh periods X1 and X2 for the second region A2. Such features can reduce polarity imbalance of a voltage to be applied to the second region A2 (i.e., a DC component to the second region A2).

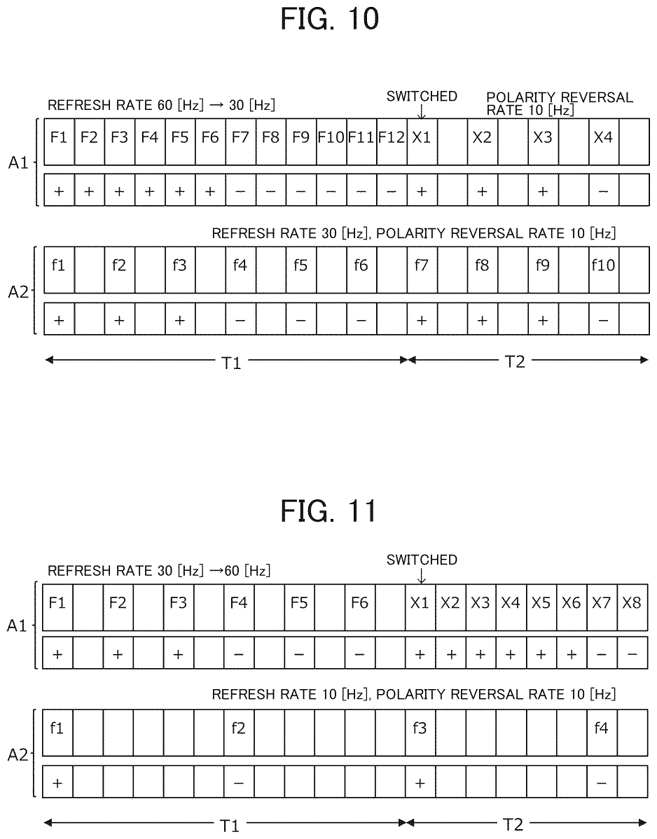

FIG. 10 illustrates an example of how the liquid crystal display device operates. FIG. 10 shows that, in the first period T1, the refresh rate (i.e., the first frequency) for the first region A1 is set to 60 [Hz] and the refresh rate (i.e., the second frequency) for the second region A2 is set to 30 [Hz]. In the first period T1, the polarity reversal rate (i.e., the common frequency) of the data signal is set to 10 [Hz] that is lower than, or equal to, the second frequency. Furthermore, in the second period T2 succeeding the first period T1, the refresh rate (i.e., the first frequency) for the first region A1 is changed (switched) to 30 [Hz]; that is, a fourth frequency. Simultaneously, the refresh rate for the second region A2 is maintained at 30 [Hz], and, in the second period T2, the polarity reversal rate (i.e., the common frequency) of the data signal is maintained at 10 [Hz].

In the second period T2, Xn represents a period (i.e., a refresh period) in which an n-th frame (n is a natural number) is refreshed for the first region region A1. Hence, the fourth frequency may be higher than, or equal to, the common frequency and lower than the first frequency.

FIG. 10 shows that, in the second period T2, the homopolar period (0.1 sec.) in which the homopolarity is maintained is longer than the refresh cycle for the second region A2. In addition, the scan periods (corresponding to X1 and X4) with polarity reversal timings of the data signal match the refresh periods f7 and f10 for the second region A2. Such features can reduce polarity imbalance of a voltage to be applied to the second region A2 (i.e., a DC component to the second region A2).

FIG. 11 illustrates an example of how the liquid crystal display device operates. FIG. 11 shows that, in the first period T1, the refresh rate (i.e., the first frequency) for the first region A1 is set to 30 [Hz] and the refresh rate (i.e., the second frequency) for the second region A2 is set to 10 [Hz]. In the first period T1, the polarity reversal rate (i.e., the common frequency) of the data signal is set to 10 [Hz] that is lower than, or equal to, the second frequency. Furthermore, in the second period T2 succeeding the first period T1, the refresh rate (i.e., the first frequency) for the first region A1 is changed (switched) to 60 [Hz]; that is, the fourth frequency. Simultaneously, the refresh rate for the second region A2 is maintained at 10 [Hz], and, in the second period T2, the polarity reversal rate (i.e., the common frequency) of the data signal is maintained at 10 [Hz]. In the second period T2, Xn represents a period (i.e., a refresh period) in which an n-th frame (n is a natural number) is refreshed for the first region A1. Hence, the fourth frequency may be higher than the first frequency.

FIG. 11 shows that, in the second period T2, the homopolar period (0.1 sec.) in which the homopolarity is maintained is the same as the refresh cycle for the second region A2. In addition, the scan periods (corresponding to X1 and X7) with polarity reversal timings of the data signal match the refresh periods f3 and f4 for the second region A2. Such features can reduce polarity imbalance of a voltage to be applied to the second region A2 (i.e., a DC component to the second region A2).

In the liquid crystal display device 10, the display unit DA may have three or more regions including the first region A1 and the second region A2 and having different refresh rates. In the first period T1, the polarity reversal rate of the data signal may be set to the common frequency in common to the three or more regions. In the liquid crystal display device 10, the common frequency may be higher than, or equal to, 30 [Hz], higher than, or equal to, 20 [Hz], higher than, or equal to, 10 [Hz], or higher than, or equal to, 5.0 [Hz]. The common frequency may be 1.0 [Hz]. The refresh rate for the second region A2 and the common frequency may be 1.0 [Hz].

In the liquid crystal display device 10, an impedance of the liquid crystal layer and an impedance of an alignment film of the liquid crystal layer may match. For example, a ratio of a product of a resistance of the alignment film and a capacitance of the alignment film to a product of a resistance of the liquid crystal layer and a capacitance of the liquid crystal is set to either 0.8 to 1.2 or 0.9 to 1.1. Such a feature can further reduce such problems as image sticking and flicker.

The control apparatus 15 illustrated in FIG. 1: supplies a data signal, a polarity of which is cyclically reversed, to the first region A1 and the second region A2 of the display unit DA included in the liquid crystal panel 5; and cyclically updates the display data of the first region A1 and the second region A2.

FIG. 2, FIG. 3, and FIG. 5 to FIG. 11 show that, as to the control apparatus 15, in the first period T1, a refresh rate for the first region A1 is set to a first frequency, and a refresh rate for the second region A2 is set to a second frequency lower than the first frequency. In the first period T1, a polarity reversal rate of the data signal is set to a common frequency in common to the first region A1 and the second region A2. The common frequency is lower than, or equal to, the second frequency.

Each of the above-described embodiments is presented not for limitative purposes but for illustrative and descriptive purposes. It will be apparent to those skilled in the art that many variations are applicable in accordance with these illustrations and descriptions.

What is claimed is:

1. A liquid crystal display device, comprising
a display unit including a first region and a second region, the first region and the second region being supplied with a data signal a polarity of which is cyclically reversed, so that display data of the first region and the second region is cyclically updated,
wherein, in a first period, a refresh rate for the first region is set to a first frequency and a refresh rate for the second region is set to a second frequency lower than the first frequency, and
in the first period, a polarity reversal rate of the data signal is set to a common frequency in common to the first region and the second region, and the common frequency is lower than, or equal to the second frequency.

2. The liquid crystal display device according to claim 1,
wherein a polarity reversal rate for the display unit as a whole is set to the common frequency.

3. The liquid crystal display device according to claim 1,
wherein the common frequency is a common divider of the first frequency and the second frequency.

4. The liquid crystal display device according to claim 1, further comprising:
a scan signal line group laid in a first direction; and a data signal line group laid in a second direction perpendicular to the first direction,
wherein the first region and the second region are different in position of the first direction.

5. The liquid crystal display device according to claim 4,
wherein the first period includes: a scan period in which a plurality of scan signal lines corresponding to the first region is scanned so that the first region is refreshed, while a plurality of scan signal lines corresponding to the second region is not scanned so that the second region is not refreshed; and a scan period in which the plurality of scan signal lines corresponding to the first region and the plurality of scan signal lines corresponding to the second region are scanned.

6. The liquid crystal display device according to claim 5,
wherein, in a scan period of the first period with a polarity reversal timing of the data signal, the plurality of scan signal lines corresponding to the first region and the plurality of scan signal lines corresponding to the second region are scanned.

7. The liquid crystal display device according to claim 1,
wherein, in a second period, if the refresh rate for the second region is changed to a third frequency, the common frequency is left unchanged.

8. The liquid crystal display device according to claim 7,
wherein the third frequency is higher than the second frequency.

9. The liquid crystal display device according to claim 7,
wherein the third frequency is higher than, or equal to, the common frequency, and lower than the second frequency.

10. The liquid crystal display device according to claim 7,
wherein the second period includes: a scan period in which a plurality of scan signal lines corresponding to the first region is scanned so that the first region is refreshed, while a plurality of scan signal lines corresponding to the second region is not scanned so that the second region is not refreshed; and a scan period in which the plurality of scan signal lines corresponding to the first region and the plurality of scan signal lines corresponding to the second region are scanned.

11. The liquid crystal display device according to claim 10,
wherein, in a scan period of the second period with a polarity reversal timing of the data signal, the plurality of scan signal lines corresponding to the first region and the plurality of scan signal lines corresponding to the second region are scanned.

12. The liquid crystal display device according to claim 11,
wherein, in the second period, even if the polarity reversal timing of the data signal does not match a timing when the second region is refreshed, the plurality of scan signal lines corresponding to the second region is scanned with the polarity reversal timing.

13. The liquid crystal display device according to claim 11,
wherein the second region is updated once or more with identical display data at an end of the first period so that a start of the second period matches the polarity reversal timing of the data signal.

14. The liquid crystal display device according to claim 1,
wherein, in a second period, if the refresh rate for the first region is changed to a fourth frequency, the common frequency is left unchanged.

15. The liquid crystal display device according to claim 14,
wherein the fourth frequency is higher than, or equal to, the common frequency, and lower than the first frequency.

16. The liquid crystal display device according to claim 14,
wherein the fourth frequency is higher than the first frequency.

17. The liquid crystal display device according to claim 1,
wherein the common frequency is lower than, or equal to, 10 [Hz].

18. The liquid crystal display device according to claim 17,
wherein the common frequency is 1.0 [Hz].

19. The liquid crystal display device according to claim 4, further comprising:
a scan driver configured to drive the scan signal line group; a data driver configured to drive the data signal line group; and a control unit configured to control the scan driver and the data driver,
wherein the control unit includes a memory in which the common frequency is stored.

20. The liquid crystal display device according to claim 1,
wherein the first region displays a moving image, and the second region displays a still image.

21. The liquid crystal display device according to claim 1,
wherein the display unit has three or more regions including the first region and the second region and having different refresh rates, and
in the first period, the polarity reversal rate of the data signal is set to the common frequency in common to the three or more regions.

22. A control apparatus for a liquid crystal panel, the control apparatus being configured to:
supply a data signal, a polarity of which is cyclically reversed, to a first region and a second region of a display unit included in a liquid crystal panel; and cyclically update display data of the first region and the second region,
wherein, in a first period, a refresh rate for the first region is set to a first frequency and a refresh rate for the second region is set to a second frequency lower than the first frequency, and
in the first period, a polarity reversal rate of the data signal is set to a common frequency in common to the first region and the second region, and the common frequency is lower than, or equal to the second frequency.
